(19) United States
(12) Patent Application Publication
(10) Pub. No.: US 2011/0261797 A1
(43) Pub. Date: Oct. 27, 2011

(54) WIRELESS COMMUNICATION DEVICE AND METHOD FOR CONTROLLING WIRELESS COMMUNICATION DEVICE

(75) Inventor: Masao Yamaguchi, Nagoya-shi (JP)

(73) Assignee: BUFFALO INC., Nagoya-shi (JP)

(21) Appl. No.: 13/094,835

(22) Filed: Apr. 27, 2011

(30) Foreign Application Priority Data
Apr. 27, 2010 (JP) 2010-101926

(51) Int. Cl. H04W 4/02

(52) U.S. Cl. 370/338

(57) ABSTRACT

A wireless communication device functioning as a wireless LAN access point includes: a first wireless LAN interface; a communication control section configured to carry out, using a first wireless LAN interface, wireless communication with wireless LAN clients on a first frequency ; an external device interface for connection with an external device; and a communication updating section configured to, when an external device having a second wireless LAN interface has been connected to the external device interface, cause the communication control section to carry out, concurrently with the wireless communication with wireless LAN client(s) using the first wireless LAN interface on the first frequency, wireless communication using the second wireless LAN interface with wireless LAN client(s) on a second frequency.

### CROSS REFERENCE TO RELATED APPLICATION

The disclosure of Japanese Patent Application No. 2010-101926, filed on Apr. 27, 2010, is incorporated herein by reference.

### BACKGROUND OF THE INVENTION

1. Field of the Invention

The present invention relates to technology whereby wireless communication takes place by means of a wireless LAN, and more particularly relates to technology whereby wireless communication takes place through a wireless LAN on a plurality of different frequencies.

2. Description of the Background Art

In the infrastructure mode of a wireless Local Area Network (LAN), wireless communications take place between wireless communication devices that function as a wireless LAN access point (hereinafter simply referred to as “wireless LAN access point” or “access point”) and wireless communication devices that function as a wireless LAN client (hereinafter simply referred to as “wireless LAN client” or “client”). In the following, a non-access-point station that functions as a client to carry out wireless or wired communication with access points will be simply referred to as a station. Generally, with wireless communications through a wireless LAN, when the number of wireless LAN clients connected to a single wireless LAN access point using the same channel on the same frequency band increases, the throughput on the network will degrade. And wireless-LAN based wireless communications on the 2.4 GHz band can be influenced by noise generated by devices apart from those on the wireless LAN, such as microwave ovens and cordless telephones.

Dual-band compatible wireless LAN access points that employ two wireless LAN interfaces to concurrently enable wireless communication on two frequency bands, the 2.4 GHz band and the 5 GHz band, are known (e.g., see Japanese Laid-Open Patent Publications No. 2006-295282 and No. 2006-93813). Via this sort of wireless LAN access point, with some wireless LAN clients wireless communication is carried out on the 2.4 GHz band, and with other wireless LAN clients wireless communication is carried out on the 5 GHz band, thereby minimizing deterioration of throughput on the network overall. Further, with such wireless LAN access points, if wireless communications on the 2.4 GHz band undergo influence from noise due to devices apart from those on the wireless LAN, the access points can switch to wireless communications on the 5 GHz band.

However, for the user using a wireless LAN access point that from the start has only one wireless LAN interface and only supports wireless communication on a single frequency band, or that selects and uses one of either of two frequency bands, in order to control loss of throughput or otherwise avoid the influence of noise due to devices other than those on the wireless LAN, it has been necessary to replace the wireless LAN access point itself with another wireless LAN access point that has a plurality of wireless LAN interfaces.

It should be noted that this sort of issue has not been limited to situations where, in wireless communications through a wireless LAN access point that has only one wireless LAN interface, increasing the classes of usable frequency bands to two is desired, but has been an issue common to situations where increasing the classes of frequencies, over the existing classes, usable in wireless communication through a wireless LAN access point has been desired.

### SUMMARY OF THE INVENTION

An object of the present invention is to increase the classes of frequency bands usable in wireless communications through a wireless LAN access point, without replacement of the wireless LAN access point.

A first aspect of the present invention is a wireless communication device functioning as a wireless LAN access point, the wireless communication device including: a first wireless LAN interface; a communication control section configured to a communication control section configured to carry out, using said first wireless LAN interface, wireless communication with wireless LAN clients on a first frequency; an external device interface for connection with an external device; and communication updating section configured to, when an external device having a second wireless LAN interface has been connected to the external device interface, cause the communication control section to carry out, concurrently with wireless communication using the first wireless LAN interface with wireless LAN client(s) on the first frequency, wireless communication using the second wireless LAN interface with wireless LAN client(s) on a second frequency that is different from the first frequency.

In this wireless communication device, when an external device having a second wireless LAN interface has been connected to the external device interface, the communication updating section causes the communication control section to carry out, concurrently with wireless communication with a wireless LAN client on a first frequency using the first wireless LAN interface, wireless communication with another wireless LAN client on a second frequency which is different from the first frequency using the second wireless LAN interface. Thus, the wireless communication device functioning as the wireless LAN access point can increase the classes of frequencies that the wireless LAN access point can use in wireless communication, without replacing the wireless LAN access point.

In a further aspect, the wireless communication device may further includes a communication switching section configured to, when the external device having the second wireless LAN interface has been connected to the external device interface, cause the communication control section to switch the wireless communication with one or more of the at least one of the wireless LAN clients that carry out the wireless communication using the first wireless LAN interface and are configured to carry out wireless communication on the second frequency, from the wireless communication using the first wireless LAN interface to the wireless communication using the second wireless LAN interface.

In this wireless communication device, when an external device having a second wireless LAN interface has been connected to the external device interface, the communication switching section causes the communication control section to switch wireless communication with at least one of the wireless LAN clients which carry out wireless communication using the first wireless LAN interface and are configured to carry out wireless communication on the second frequency, from the wireless communication using the first wireless LAN interface to wireless communication using the second wireless LAN interface. Thus, it is possible to reduce the number of wireless LAN clients which carry out communication with the wireless communication device, which functions as the wireless LAN access point, on the same frequency, and also possible to improve the substantial throughput of the whole network. In addition, with the wireless communication device, it is possible to avoid influence of noises generated from devices, other than wireless LAN devices, such as microwave ovens or cordless telephones, on the wireless communication with at least one of the wireless LAN clients.

In a further aspect, the communication updating section may cause the communication control section to carry out the wireless communication using the first wireless LAN interface and the wireless communication using the second wireless LAN interface using a single network identifier, and the communication switching section may cause the communication control section to stop transmitting responses to the wireless LAN clients using the first wireless LAN interface when the external device having the second wireless LAN interface has been connected to the external device interface, and to restart transmitting the responses to the wireless LAN clients using the first wireless LAN interface after a lapse of a predetermined period of time.

With this wireless communication device, when an external device having a second wireless LAN interface has been connected to the external device interface, the communication switching section causes the communication control section to stop transmitting responses to wireless LAN clients using the first wireless LAN interface. Accordingly, wireless communication with the wireless LAN clients by the communication control section using the first wireless LAN interface is discontinued. Here, since the communication updating section causes the communication control section to carry out wireless communication using the first wireless LAN interface and wireless communication using the second wireless LAN interface using the same network identifier, the wireless communication with at least one of the wireless LAN clients which are also configured to carry out wireless communication on the second frequency is switched to the wireless communication using the second wireless LAN interface. Further, after a lapse of a predetermined period of time, if the communication switching section causes the communication control section to restart transmitting responses to the wireless LAN clients using the first wireless LAN interface, the wireless communication with the wireless LAN clients by the communication control section using the first wireless LAN interface is restarted. Therefore, in the wireless communication device, when an external device having a second wireless LAN interface has been connected to the external device interface, the wireless communication by at least one of the wireless LAN clients that are also wirelessly communicable on the second frequency is switched from the wireless communication using the first wireless LAN interface to the wireless communication using the second wireless LAN interface.

In a further aspect, the communication updating section may cause the communication control section to carry out the wireless communication using the first wireless LAN interface and the wireless communication using the second wireless LAN interface using a single network identifier, and the communication switching section may collect corresponding frequency information which indicates whether the wireless LAN clients carrying out the wireless communication are configured to carry out the wireless communication on the second frequency, and refer to the corresponding frequency information when the external device having the second wireless LAN interface has been connected to the external device interface, to cause the communication control section to stop transmitting, using the first wireless LAN interface, responses to the at least one of the wireless LAN clients that are configured to carry out the wireless communication on the second frequency.

The wireless communication device collects the corresponding frequency information which indicates whether wireless LAN clients which are in wireless communication with the wireless communication device are configured to carry out wireless communication on the second frequency. When an external device having a second wireless LAN interface has been connected to the external device interface, the communication switching section refers to the corresponding frequency information, and causes the communication control section to stop transmitting using the first wireless LAN interface a response to at least one of the wireless LAN clients that are configured to carry out the wireless communication on the second frequency. Accordingly, wireless communication using the first wireless LAN interface with the at least one of the wireless LAN clients by the communication control section is discontinued. Since the communication updating section causes the communication control section to carry out the wireless communication using the first wireless LAN interface and the wireless communication using the second wireless LAN interface using the same network identifier, the wireless communication with at least one of the wireless LAN clients that are also configured to carry out wireless communication on the second frequency is switched to the wireless communication using the second wireless LAN interface. Thus, with the wireless communication device, when an external device having a second wireless LAN interface has been connected to the external device interface, the wireless communication with at least one of the wireless LAN clients that are also configured to carry out wireless communication on the second frequency can be switched from the wireless communication using the first wireless LAN interface to the wireless communication using the second wireless LAN interface.

In a further aspect, the communication switching section may refer to the corresponding frequency information to select at least one of the wireless LAN clients with respect to whom transmission of the response using the first wireless LAN interface is to be stopped, so that a load of the wireless communication using the first wireless LAN interface and a load of the wireless communication using the second wireless LAN interface, which are carried out by the communication control section, are substantially equal to each other.

In this wireless communication device, in order to improve the throughput of wireless communication using the first wireless LAN interface and wireless communication using the second wireless LAN interface in a balanced manner, the wireless communication with at least one of the wireless LAN clients that are also configured to carry out wireless communication on the second frequency can be switched from the wireless communication using the first wireless LAN interface to the wireless communication using the second wireless LAN interface.

In a further aspect, the communication updating section may cause the communication control section to carry out the wireless communication using the first wireless LAN interface and the wireless communication using the second wireless LAN interface using a single network identifier and a single set of authentication and encryption parameters.

In this wireless communication device, since the communication updating section causes the communication control section to carry out wireless communication using the first wireless LAN interface and wireless communication using the second wireless LAN interface using the same network identifier and the same authentication and encryption parameters, it is possible to switch the wireless communication with at least one of the wireless LAN clients that are also configured to carry out wireless communication with the second frequency to the wireless communication using the second wireless LAN interface after the wireless communication by the communication control section with the wireless LAN clients using the first wireless LAN interface is discontinued.

In a further aspect, the communication updating section may obtain a maintenance program file for updating a function of the communication control section, executes the maintenance program file, and update the function of the communication control section so that the communication control section is configured to carry out, concurrently with the wireless communication on the first frequency using the first wireless LAN interface, wireless communication on the second frequency using the second wireless LAN interface.

In this wireless communication device, the communication updating section causes the communication control section to carry out, concurrently with the wireless communication with wireless LAN clients on the first frequency using the wireless LAN interface, wireless communication with wireless LAN clients on the second frequency which is different from the first frequency using the second wireless LAN interface.

In a further aspect, the wireless communication device further may further include an external network interface for connection with an external network. The communication updating section may be configured to obtain the maintenance program file, which is stored in predetermined storage means on the external network, using the external network interface.

In this wireless communication device, the communication updating section obtains and executes the maintenance program file stored in predetermined storage means on an external network, and then causes the communication control section to carry out, concurrently with the wireless communication with wireless LAN clients on the first frequency using the first wireless LAN interface, wireless communication with wireless LAN clients on the second frequency which is different from the first frequency using the second wireless LAN interface.

In a further aspect, the external device having the second wireless LAN interface may include storage means for storing the maintenance program file, and the communication updating section may obtain, using the external device interface, the maintenance program file stored in the storage means of the external device.

In this wireless communication device, the communication updating section obtains and executes a maintenance program file stored in storage means of an external device, and then causes the communication control section to carry out wireless communication with wireless LAN clients on the first frequency using the first wireless LAN interface and the wireless communication with wireless LAN clients on the second frequency which is different from the first frequency using the second wireless LAN interface.

Another aspect of the present invention is a method for controlling a wireless communication device which includes a first wireless LAN interface and an external device interface for connection with an external device, and which functions as a wireless LAN access point, and the method includes the processes of (a) causing the wireless communication device to carry out, using the first wireless LAN interface, wireless communication with wireless LAN clients on a first frequency; and (b) causing the wireless communication device, when the external device which has a second wireless LAN interface has been connected to the external device interface, to carry out, concurrently with wireless communication with the wireless LAN client(s) on the first frequency using the first wireless LAN interface, wireless communication using the second wireless LAN interface with wireless LAN client(s) on a second frequency that is different from the first frequency.

### BRIEF DESCRIPTION OF THE DRAWINGS

FIG. 1 is a diagram schematically illustrating the configuration of a wireless communication system 10 according to a first embodiment of the present invention;

FIG. 2 is a diagram illustrating the configuration of an access point 20 according to the first embodiment;

FIG. 3 is a flowchart showing flow of a communication updating process according to the first embodiment;

FIG. 4 is a flowchart showing flow of a communication switching process according to the first embodiment;

FIG. 5 is a diagram showing frequency bands used for wireless communication by respective clients CL before and after the communication switching process according to the first embodiment;

FIG. 6 is a flowchart showing flow of a communication switching process according to a second embodiment of the present invention;

FIG. 7 is a flowchart showing flow of a communication switching process according to a third embodiment of the present invention;

FIG. 8 is a diagram showing examples of frequency information FI correspondences; and

FIG. 9 is a diagram illustrating one example of a pattern for a communication updating process to which the present invention is applicable.

### DESCRIPTION OF THE PREFERRED EMBODIMENTS

Next, embodiments of the present invention will be described.

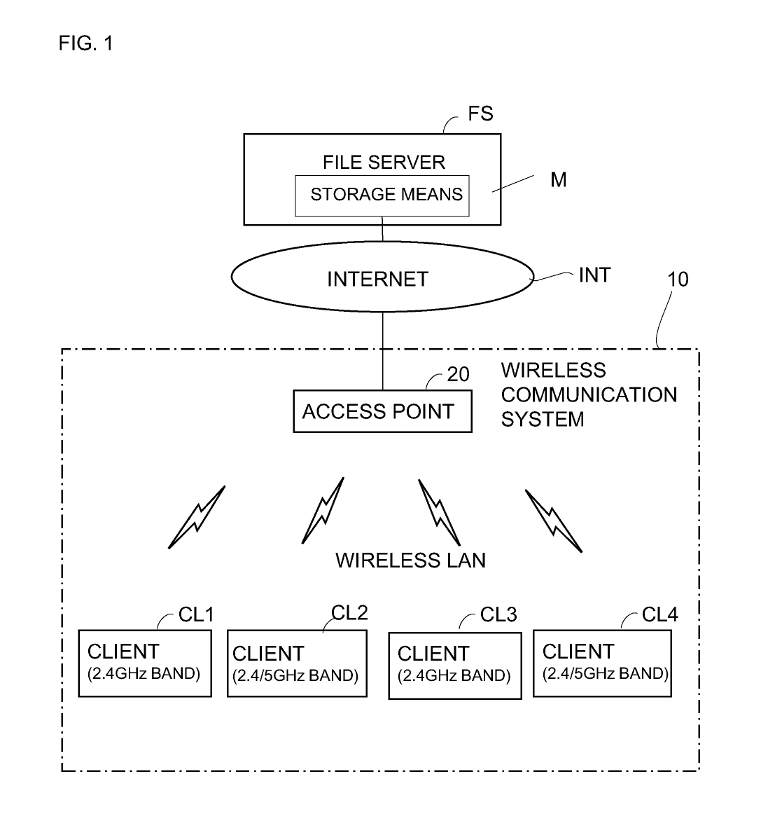

FIG. 1 is a diagram schematically illustrating the configuration of a wireless communication system 10 according to a first embodiment of the present invention. The wireless communication system 10 according to this embodiment includes a wireless communication device 20 (access point 20) that functions as a wireless LAN access point, and four wireless communication devices CL (clients CL1 to CL4) that function as wireless LAN clients. The access point 20 and four clients CL are wireless communication devices compliant with the 802.11 standard of the institute of electrical and electronics engineers (IEEE) for wireless LAN. The access point 20 and the clients CL carry out wireless communication in wireless LAN infrastructure mode.

It should be noted that, as illustrated in FIG. 1, client CL1 and client CL3 support wireless communication on the 2.4 GHz band (e.g., wireless communication compliant with IEEE 802.11b/g/n), but do not support wireless communication on the 5 GHz band (e.g., wireless communication compliant with IEEE 802.11a/n). On the other hand, client CL2 and client CL4 support both wireless communication on the 2.4 GHz band and wireless communication on the 5 GHz band.

The access point 20 has a routing function of connecting a wireless LAN, which is established by the access point 20 and the clients CL, to the Internet INT, as a network external to the wireless communication system 10, and relays communication between the clients CL and an apparatus (e.g., a file server FS) on the Internet INT.

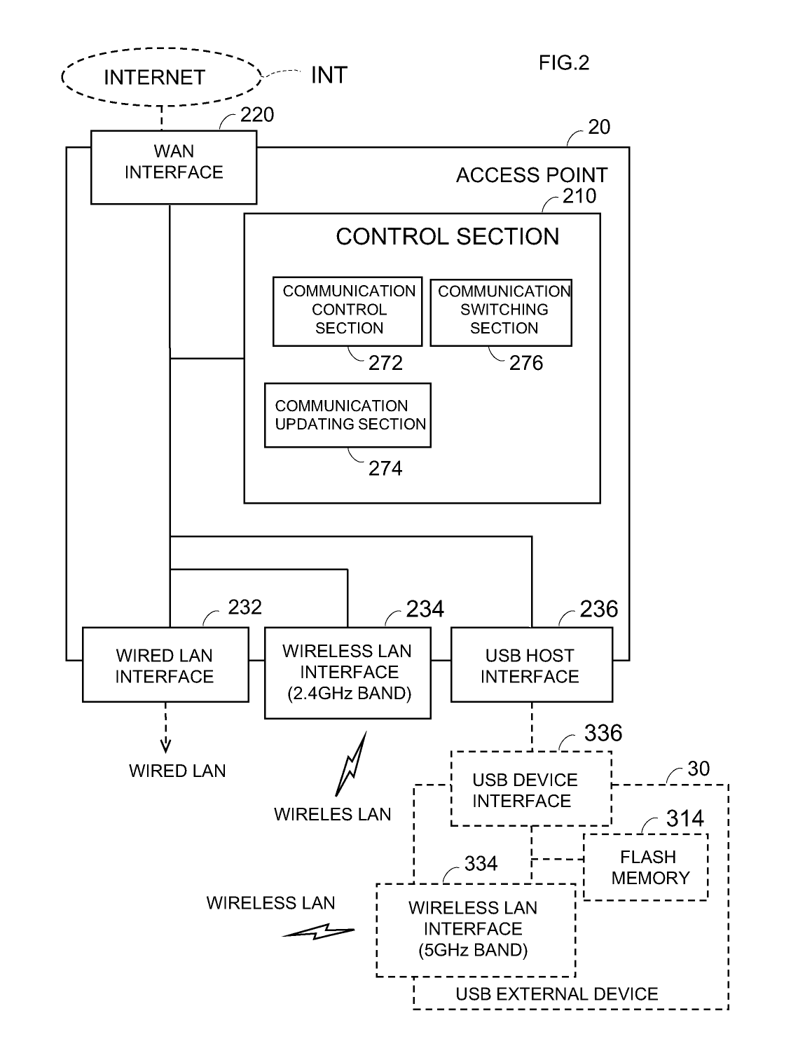

FIG. 2 is a diagram illustrating the configuration of the access point 20 according to this embodiment. The access point 20 according to this embodiment includes a control section 210, a Wide Area Network (WAN) interface 220, a wired LAN interface 232, a wireless LAN interface 234, and a Universal Serial Bus (USB) host interface 236.

The WAN interface 220 is used for communication with an external network such as the Internet INT. The access point 20 has a routing function, and relays communication between a LAN and the external network via the WAN interface 220. The wired LAN interface 232 is used for communication in a wired LAN compliant with the IEEE 802.3 standard. The wireless LAN interface 234 is used for communication with clients CL (FIG. 1) in a wireless LAN on the 2.4 GHz band (e.g., wireless LAN compliant with the IEEE 802.11b/g/n). The USB host interface 236 is used for establishing a connection with a USB external device 30, which is a USB device. The USB host interface 236 and a control section 210 of a CPU 20 to be described later function as a USB host controller. FIG. 2 illustrates a state in which the USB host interface 236 of the access point 20 establishes a connection with a USB device interface 336 of a USB external device 30.

The USB external device 30 in this embodiment includes a wireless LAN interface 334. The wireless LAN interface 334 of the USB external device 30 enables communication in a wireless LAN (e.g., wireless LAN compliant with the IEEE 802.11a/n standard) on the 5 GHz band. The USB external device 30 in this embodiment is connectable to a USB host interface of an apparatus such as a personal computer to cause the apparatus to function as a wireless LAN client. Further, the USB external device 30 in this embodiment may also include a flash memory (storage means) 314 having a maintenance program file stored therein.

The access point 20 includes a central processing unit (CPU) (not illustrated). The CPU of the access point 20 executes a program (firmware) stored in predetermined storage means (not illustrated) provided in the access point 20, and functions as a control section 210 which controls respective components of the access point 20. The control section 210 includes a communication control section 272, a communication updating section 274, and a communication switching section 276. The communication control section 272 controls the respective communication interfaces (wireless LAN interface 234, wired LAN interface 232, and WAN interface 220) to allow the access point 20 to carry out communication with the clients CL, the wired LAN device, and the external network. The communication updating section 274 performs a communication updating process, to be described later, when the USB external device 30 having the wireless LAN interface 334 has been connected to the USB host interface 236. The communication switching section 276 performs a communication switching process, to be described later, when the USB external device 30 has been connected to the USB host interface 236.

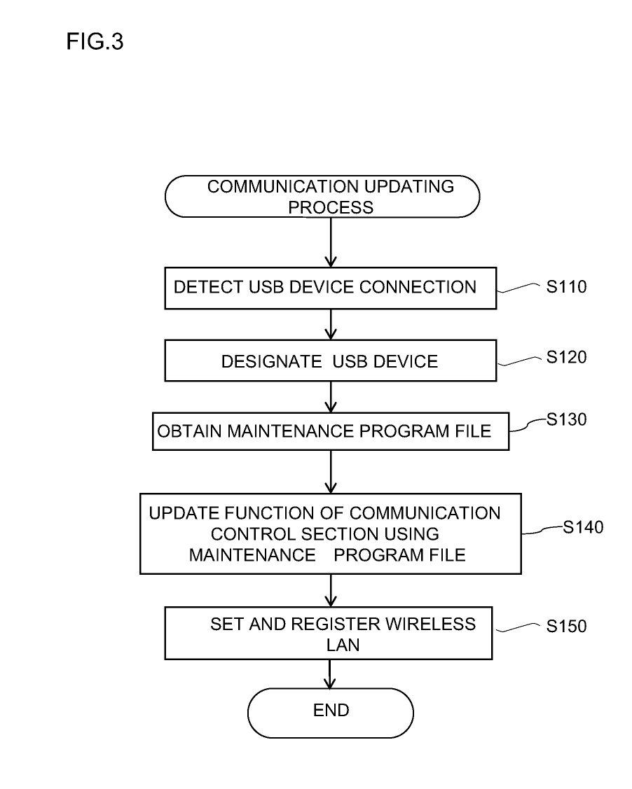

FIG. 3 is a flowchart showing flow of the communication updating process according to this embodiment. When the USB external device 30 having the wireless LAN interface 334 has been connected to the USB host interface 236 of the access point 20 (FIG. 2), the communication updating process causes the communication control section 272 to carry out wireless communication with clients CL on the 5 GHz band using the wireless LAN interface 334 of the USB external device 30 concurrently with wireless communication with clients CL on the 2.4 GHz band using the wireless LAN interface 234. In this description, the wireless LAN interface 234 of the access point 20 is also referred to as a preexisting wireless LAN interface 234, and the wireless LAN interface 334 of the USB external device 30 is also referred to as an added-on wireless LAN interface 334.

When the USB external device 30 is connected to the USB host interface 236 of the access point 20, the control section 210 detects that a USB device is connected to the USB host interface 236 (step S110). The control section 210 designates the type of the USB device connected to the USB host interface 236 according to, for example, a vendor ID or a product ID obtained from the USB device (step S 120). In this embodiment, the control section 210 detects that the connected USB device is the USB external device 30 having the wireless LAN interface 334.

Next, the communication updating section 274 obtains a maintenance program file (step S 130). The maintenance program file is used for updating the function of the communication control section 272. More specifically, the maintenance program file updates firmware to cause the CPU of the access point 20 to function as the control section 210 so as to cause the communication control section 272 to enable wireless communication on the 2.4 GHz band using the preexisting wireless LAN interface 234 concurrently with wireless communication on the 5 GHz band using the added-on wireless LAN interface 334.

In this embodiment, a maintenance program file corresponding to the type of the USB external device 30 is stored in predetermined storage means M in a file server FS on the Internet INT (FIG. 1). The communication updating section 274 accesses the file server FS on the Internet INT, using the router function of the access point 20, to obtain the maintenance program file stored in the file server FS. The address of the storage means M in the file server FS to be accessed for obtaining the maintenance program file is preestablished, and is stored in the control section 210. Alternatively, the address of the storage means M in the file server FS may be designated by the user, or may be designated based on information obtained from the USB external device 30.

Further, if the maintenance program file is preliminarily stored in the predetermined storage means in the access point 20 as a part of firmware, for example, the communication updating section 274 may obtain the maintenance program file from the predetermined storage means. In addition, if the USB external device 30 includes the flash memory 314, and the flash memory 314 has the maintenance program file stored therein, then the communication updating section 274 may use the “AutoRun” function, for example, to obtain the maintenance program file from the flash memory 314 of the USB external device 30. The predetermined storage means in the access point 20 may preliminarily store firmware that is used in cases where there is no connection with a USB external device 30, and firmware that is used in cases where there is a connection with a USB external device 30 (firmware according to the frequency compatible with the wireless LAN interface 334 of the USB external device 30), so that the communication updating section 274 will select the appropriate firmware depending on whether a connection is established with a USB external device 30 or according to the frequency compatible with the connected USB external device 30, and renders the selected firmware operable.

The communication updating section 274 updates the function of the communication control section 272 by using the obtained maintenance program file (step S140). Specifically, the communication updating section 274 executes the maintenance program file to update the function of the communication control section 272 so as to enable the wireless communication on the 5 GHz band using the added-on wireless LAN interface 334 concurrently with the wireless communication on the 2.4 GHz band using the preexisting wireless LAN interface 234.

The communication updating section 274 performs various settings and registrations relating to wireless LAN in which communication takes place on the 5 GHz band using the added-on wireless LAN interface 334 (step S150). Specifically, the communication updating section 274 configures the Service Set Identifier (SSID) which is a network identifier, and encryption mode, encryption key, etc., and also registers the added-on wireless LAN interface 334 as a wireless LAN interface. The communication updating section 274 sets the SSID and authentication/encryption parameters (encryption mode and encryption key) of the wireless LAN in which communication takes place on the 5 GHz band using the added-on wireless LAN interface 334 to be the same as the SSID and the authentication/encryption parameters of the wireless LAN in which communication is carried out on the 2.4 GHz band using the preexisting wireless LAN interface 234.

With the above-described communication updating process, the access point 20, which is configured to carry out wireless communication on the 2.4 GHz band using the preexisting wireless LAN interface 234 but is not configured to carry out wireless communication on the 5 GHz band unless the USB external device 30 is connected to the access point 20, is enabled to function as an access point which is configured to carry out the wireless communication on the 5 GHz band using the added-on wireless LAN interface 334 concurrently with the wireless communication on the 2.4 GHz band using the preexisting wireless LAN interface 234. Thus, with the communication updating process in this embodiment, it is possible to increase the class of frequencies which the access point 20 can use for wireless communication, and it is not necessary to replace the access point 20.

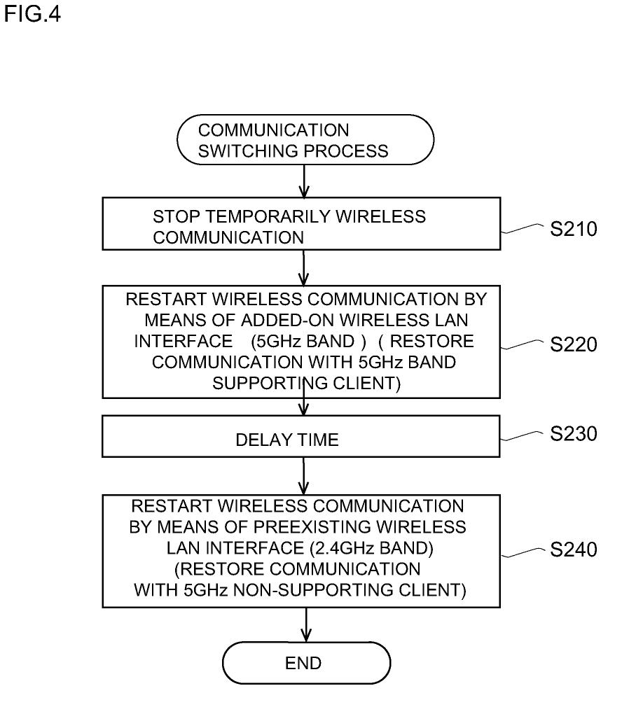

FIG. 4 is a flowchart showing flow of the communication switching process according to the first embodiment. When the USB external device 30 having the wireless LAN interface 334 is connected to the USB host interface 236 of the access point 20 (FIG. 2), and then the communication updating process enables the access point 20 to carry out the wireless communication on the 5 GHz band using the added-on wireless LAN interface 334 concurrently with the wireless communication on the 2.4 GHz band using the preexisting wireless LAN interface 234, the communication switching process switches the wireless communication with the clients CL which are also configured to carry out the wireless communication on 5 GHz band from the wireless communication using the preexisting wireless LAN interface 234 to that using the added-on wireless LAN interface 334.

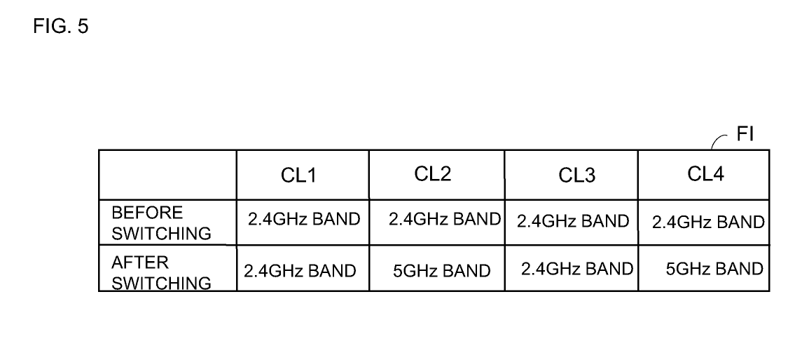

FIG. 5 is a diagram illustrating frequency bands used for wireless communication carried out by the respective clients CL before and after the communication switching process in this embodiment. Before the communication switching process, all the clients CL carry out wireless communication on the 2.4 GHz band via the preexisting wireless LAN interface 234 of the access point 20.

The communication switching section 276 (FIG. 2) causes the communication control section 272 to temporarily stop the wireless communication using the preexisting wireless LAN interface 234 and that by mean of the added-on wireless LAN interface 334 (step S210). Accordingly, the access point 20 discontinues transmission of beacons, reception of probe requests transmitted from the clients CL, and transmission of responses to the probe requests. When the access point 20 discontinues the wireless communication, the wireless connection between the clients CL and the access point 20 is disconnected, and thus, the clients CL broadcast their probe requests including the respective SSIDs, which are used before stoppage of the wireless communication, in accordance with the IEEE 802.11 standard.

Next, the communication switching section 276 causes the communication control section 272 to start wireless communication on the 5 GHz band using the added-on wireless LAN interface 334 (step S220). At this time, the wireless communication on the 2.4 GHz band using the preexisting wireless LAN interface 234 is still being discontinued. As described above, in this embodiment, the SSID and the authentication/encryption parameters (encryption mode and encryption key) of the wireless LAN in which communication takes place using the added-on wireless LAN interface 334 are set to be the same as those of the SSID and the authentication/encryption parameters (encryption mode encryption key) of the wireless LAN in which communication takes place using the preexisting wireless LAN interface 234. Thus, when the wireless communication on the 5 GHz band using the added-on wireless LAN interface 334 starts, the communication control section 272 receives, using the added-on wireless LAN interface 334, probe requests from the clients CL (client CL2 or CL4) that support both of the wireless communication on the 2.4 GHz band and the wireless communication on the 5 GHz band. When the communication control section 272 has confirmed that the SSIDs included in the probe requests are the same as the SSID of the wireless communication using the added-on wireless LAN interface 334, the communication control section 272 transmits probe responses to the clients CL2 and CL4. Then, based on the authentication/encryption parameters, an authentication process is performed between each of the clients CL2 and CL4, and the added-on wireless LAN interface 334. Accordingly, the wireless communication on the 5 GHz band using the added-on wireless LAN interface 334 is started between the access point 20 and the clients CL2 and CL4.

Meanwhile, at this stage, the access point 20 cannot receive probe requests from the clients CL (client CL1 and CL3) that support the wireless communication on the 2.4 GHz band but do not support the wireless communication on the 5 GHz band. Thus, the client CL1 and CL3 are wirelessly disconnected to the access point 20.

After the wireless communication on the 5 GHz band using the added-on wireless LAN interface 334 starts, and after a lapse of a predetermined delay time (step S230), the communication switching section 276 causes the communication control section 272 to restart the wireless communication on the 2.4 GHz band using the preexisting wireless LAN interface 234 (step S240). Accordingly, the communication control section 272 receives, using the preexisting wireless LAN interface 234, probe requests from the client CL1 and CL3 that support the wireless communication on the 2.4 GHz band but do not support the wireless communication on the 5 GHz band. When the communication control section 272 has confirmed that the SSIDs included in the received probe requests are the same as the SSID of the wireless communication using the preexisting wireless LAN interface 234, the communication control section 272 transmits probe responses to the client CL1 and CL3. Accordingly, the wireless communication on the 2.4 GHz band using the preexisting wireless LAN interface 234 is restarted between the access point 20 and the clients CL1 and CL3.

As illustrated in FIG. 5, the above-described communication switching process enables automatic switching of the wireless communication from the wireless communication on the 2.4 GHz band using the preexisting wireless LAN interface 234 to the wireless communication on the 5 GHz band using the added-on wireless LAN interface 334, with respect to the wireless communication carried out with two out of four clients CL (clients CL2 and CL4) that carry out the wireless communication with the access point 20 on the 2.4 GHz band and are also configured to carry out wireless communication on the 5 GHz band. Generally, if the number of the clients increases, which are connected to an access point, for carrying out wireless communication in a wireless LAN, using a single channel on a single frequency band, the substantial throughput of the whole network tends to degrade. Since the communication switching process in this embodiment can reduce the number of clients CL carrying out wireless communication with the access point 20 on the 2.4 GHz band using the preexisting wireless LAN interface 234, the substantial throughput of the whole network can be improved. Further, the clients CL (clients CL2 and CL4) that are also configured to carry out the wireless communication on the 5 GHz band can avoid influence of noises from devices, other than the wireless LAN, such as a microwave oven and a cordless telephone.

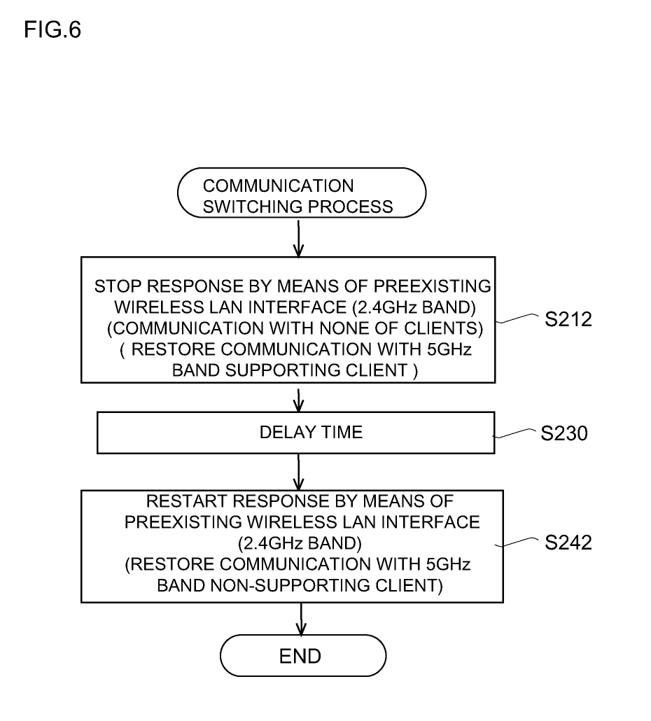

FIG. 6 is a flowchart showing flow of a communication switching process according to a second embodiment. In this embodiment, unlike the first embodiment, transmission of wireless LAN responses using the preexisting wireless LAN interface 234 are discontinued in the communication switching process, whereas transmission of the wireless LAN responses using the added-on wireless LAN interface 334 is continued. That is, in the communication switching process in this embodiment, the communication switching section 276 (FIG. 2) causes the communication control section 272 to temporarily stop transmitting the wireless LAN responses using the preexisting wireless LAN interface 234 (step S212). Accordingly, even if the access point 20 receives data frames transmitted from the clients CL, the access point 20 does not transmit the responses to the clients CL using the preexisting wireless LAN interface 234. Thus, the wireless communication between each client CL and the access point 20 cannot be established.

When wireless communication between each client CL and the access point 20 is not established, the client CL broadcasts a probe request including the SSID in accordance with the IEEE 802.11 standard. At this time, transmission of wireless LAN responses using the added-on wireless LAN interface 334 from the communication control section 272 is not stopped. Thus, when the communication control section 272 receives probe requests from the clients CL (clients CL2 and CL4) that support both the wireless communication on the 2.4 GHz band using the added-on wireless LAN interface 334 and the wireless communication on the 5 GHz band, the communication control section 272 checks if the SSIDs included in the probe requests are the same as the SSID of the wireless communication using the added-on wireless LAN interface 334, and transmits probe responses to the clients CL2 and CL4. Accordingly, the wireless communication on the 5 GHz band using the added-on wireless LAN interface 334 takes place between the access point 20 and the client CL2 and CL4.

After the wireless communication on the 5 GHz band using the added-on wireless LAN interface 334 starts, and after a lapse of a predetermined period of delay time (step S230), the communication switching section 276 causes the communication control section 272 to restart transmitting wireless LAN responses using the preexisting wireless LAN interface 234 (step S242). Thereafter, when the communication control section 272 receives using the preexisting wireless LAN interface 234, probe requests from the clients CL1 and CL3 that are compatible with the wireless communication on the 2.4 GHz band but do not support the wireless communication on the 5 GHz band, the communication control section 272 checks if the SSIDs included in the probe requests are the same as the SSID of the wireless communication using the preexisting wireless LAN interface 234, and transmits probe responses to the clients CL1 and CL3. Accordingly, the wireless communication on the 2.4 GHz band using the preexisting wireless LAN interface 234 is restarted between the access point 20 and the clients CL1 and the CL3.

Similarly to the communication switching process in the first embodiment, the communication switching process of the above-described second embodiment enables automatic switching of the wireless communication on the 2.4 GHz band using the preexisting wireless LAN interface 234 to the wireless communication on the 5 GHz band using the added-on wireless LAN interface 334, with respect to the wireless communication carried out with two out of four clients CL (clients CL2 and CL4) that carry out the wireless communication with the access point 20 on the 2.4 GHz band, and are also configured to carry out wireless communication with the access point 20 on the 5 GHz band.

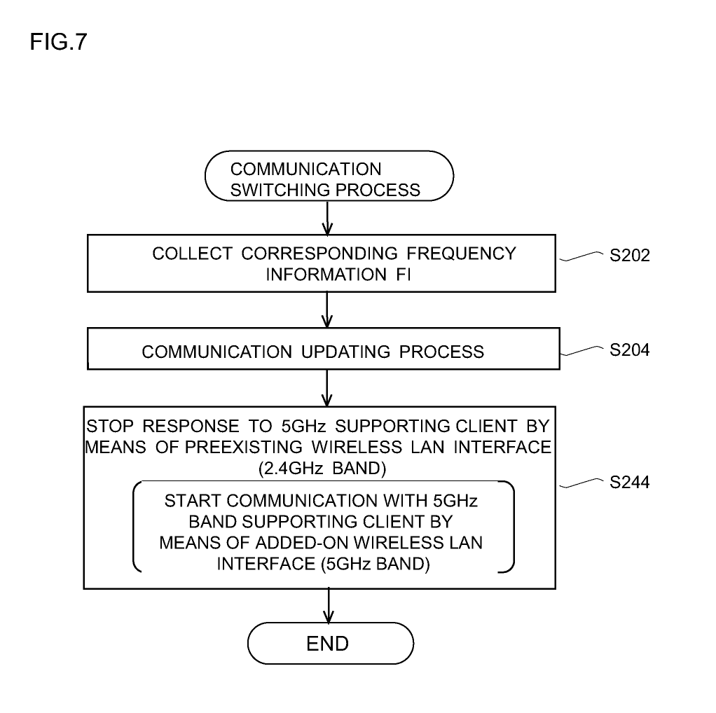

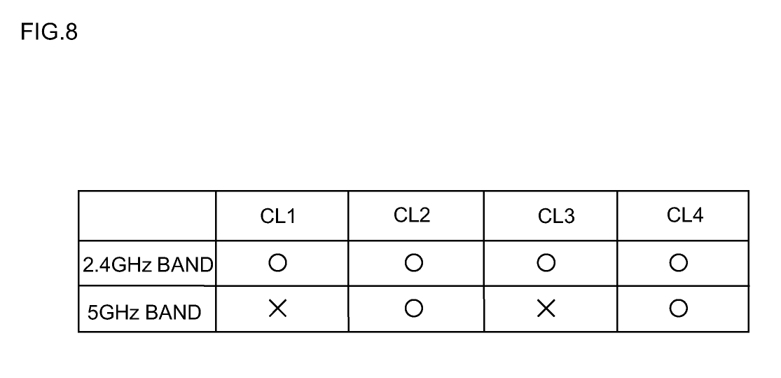

FIG. 7 is a flowchart showing flow of a communication switching process according to a third embodiment. In the communication switching process according to this embodiment, the communication switching section 276 collects corresponding frequency information FI before the communication updating process (step S204, see FIG. 3). FIG. 8 is a diagram showing an example of the corresponding frequency information FI. The corresponding frequency information FI in this embodiment indicates whether the clients CL which carry out wireless communication with the access point 20 on the 2.4 GHz band are configured to carry out wireless communication on the 5 GHz band. The corresponding frequency information FI shown in FIG. 8 indicates that two clients CL (clients CL2 and CL4) are configured to carry out wireless communication on the 5 GHz band and the other two clients CL (clients CL1 and CL3) are not configured to carry out wireless communication on the 5 GHz band. For example, the communication switching section 276 can collect the corresponding frequency information FI if a bit indicating whether the client CL is configured to carry out wireless communication on the 5 GHz band is added to a predetermined position of a probe request from each client CL. Alternatively, the communication switching section 276 can collect the corresponding frequency information FI by obtaining information, inputted by a user, indicating whether each client CL is configured to carry out wireless communication on the 5 GHz band.

In the communication switching process in this embodiment, after the communication updating process (step S204 see FIG. 3), the communication switching section 276 (FIG. 2) refers to the corresponding frequency information FI to designate the clients CL (client CL2 and CL4) that are configured to carry out wireless communication on the 5 GHz band, and causes the communication control section 272 to stop transmitting wireless LAN responses to the designated clients CL using the preexisting wireless LAN interface 234 (step S244). Accordingly, the access point 20 does not transmit responses even if the access point 20 receives data frames transmitted from the clients CL2 and CL4. Thus, wireless communication between the access point 20 and the clients CL2 and CL4 which are configured to carry out wireless communication on the 5 GHz band is not established. Meanwhile, the access point 20 continuously transmits wireless LAN responses using the preexisting wireless LAN interface 234 to the clients CL other than the clients CL2 and CL4 (i.e., the clients CL1 and CL3 which are not configured to carry out wireless communication on the 5 GHz band), and thus the wireless communication between the access point 20 and the clients CL1 and CL3 takes place continuously.

When the wireless communication between the access point 20 and the clients CL2 and CL4 which are configured to carry out wireless communication on 5 GHz band is discontinued, the clients CL2 and CL4 broadcast probe requests including the SSIDs in accordance with the IEEE 802.11 standard. At this time, the communication control section 272 does not stop transmission of wireless LAN responses using the added-on wireless LAN interface 334. Thus, when the communication control section 272 has received, using the added-on wireless LAN interface 334, probe requests from the clients CL2 and CL4, the communication control section 272 checks if the SSIDs included in the probe requests are the same as the SSID of the wireless communication using the added-on wireless LAN interface 334, and transmits probe responses to the clients CL2 and CL4. Accordingly, wireless communication on the 5 GHz band using the added-on wireless LAN interface 334 is restarted between the access point 20 and the clients CL2 and CL4.

Similarly to the communication switching process in the first embodiment, the communication switching process in the above-described third embodiment enables automatic switching of the wireless communication on the 2.4 GHz band using the preexisting wireless LAN interface 234 to the wireless communication on the 5 GHz band using the added-on wireless LAN interface 334, with respect to the wireless communication carried out with two out of four clients CL (clients CL2 and CL4) that carry out the wireless communication with the access point 20 on the 2.4 GHz band, and are also configured to carry out wireless communication with the access point 20 on the 5 GHz band.

In the above description, the clients CL that are configured to carry out wireless communication on the 5 GHz band are designated by referring to the corresponding frequency information FI, and the wireless communication between the access point 20 and all the designated clients CL is switched to the wireless communication on the 5 GHz band using the added-on wireless LAN interface 334. However, the wireless communication with some of the designated clients CL may be switched to the wireless communication on the 5 GHz band. In the case, the client CL that is a target of the switching to the wireless communication on the 5 GHz band may be selected such that a load of the wireless communication using the preexisting wireless LAN interface 234 and a load of the wireless communication using the added-on wireless LAN interface 334, which are performed by the communication control section 272 of the access point 20, are substantially equal to each other. Accordingly, with the communication switching process, the throughput of the wireless communication on the 2.4 GHz band and the wireless communication on the 5 GHz band can be improved in a balanced manner.

It should be noted that the prevent invention is not limited to the above embodiments, but may embodied in various modes without departing from the spirit and scope thereof. For example, the following modifications may be applicable.

The configuration of the wireless communication system 10 described in the above embodiments is an example, and various modifications are possible. For example, in the above embodiments, the wireless communication system 10 includes four clients CL, but the number of the clients CL included in the wireless communication system 10 is not limited. Further, in the above embodiments, the access point 20 has the USB host interface 236 as an external device interface, and the USB external device 30 having the wireless LAN interface 334 is connected to the access point 20 via the USB host interface 236. However, the access point 20 may have a predetermined external device interface (e.g., an IEEE 1394 interface) other than the USB host interface 236, and connect to an external device having a wireless LAN interface via the external device interface. Further, in the above embodiments, the access point 20 includes the wired LAN interface 232, but the access point 20 need not necessarily have the wired LAN interface 232.

Further, in the above respective embodiments, some of the components that are realized by hardware may be realized by software. Conversely, some of the components that are realized by software may be realized by hardware. Further, when some or all of the functions of the components of the present invention are realized by software, the software (computer program) may be provided by means of a computer readable storage medium. In the present invention, the “computer readable storage medium” includes not only a storage medium such as a flexible disk and a CD-ROM, but also a storage device included in a computer such as a ROMs and a RAM, and a storage device externally fixed to the computer such as a hard disk.

In the above embodiments, the communication updating process has been described to cause, when the USB external device 30 having the added-on wireless LAN interface 334 is connected to the access point 20 which is carrying out the wireless communication with the clients CL on the 2.4 GHz band using the preexisting wireless LAN interface 234, the communication control section 272 to carry out the wireless communication on the 5 GHz band using the added-on wireless LAN interface 334 concurrently with the wireless communication on the 2.4 GHz band. However, in the present invention, instead of the above communication updating process, a communication updating process may applicable which causes the communication control section 272 to carry out wireless communication with a client CL on a first frequency using the preexisting wireless LAN interface 234 concurrently with wireless communication with a client CL on a second frequency, which is different from the first frequency, using the added-on wireless LAN interface 334. In this case, not only the frequency band to be used for the wireless LAN communication but also the channel to be used varies. That is, by using various channels on a single frequency band, various frequencies can be used. Thus, by using the various channels, wireless communication is carried out using the preexisting wireless LAN interface 234 concurrently with the added-on wireless LAN interface 334.

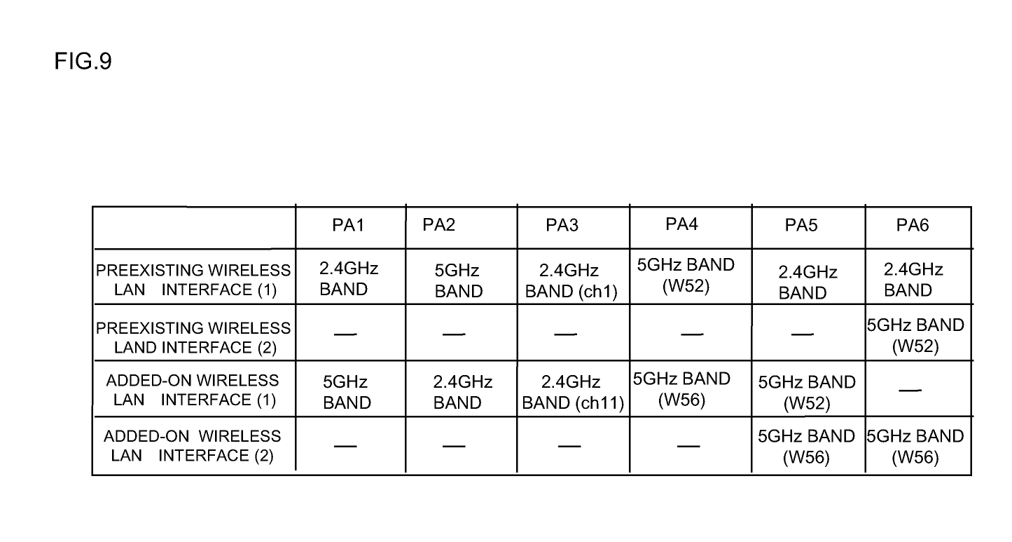

FIG. 9 is a diagram illustrating examples of the pattern of the communication updating process applicable to the present invention. The pattern PA1 illustrated in FIG. 9 is the pattern of the communication updating process in each of the above embodiments. Like the pattern PA2 illustrated in FIG. 9, the communication updating process may be a process which causes the access point 20 which carries out the wireless communication on the 5 GHz band using the preexisting wireless LAN interface 234 to concurrently carry out the wireless communication on the 2.4 GHz band using the added-on wireless LAN interface 334. Alternatively, like the pattern PA3 illustrated in FIG. 9, the communication updating process may be a process which causes the access point 20 which carries out wireless communication using one channel ch1 on the 2.4 GHz band using the preexisting wireless LAN interface 234 to concurrently carry out wireless communication using another channel ch11 on the 2.4 GHz band using the added-on wireless LAN interface 334. Alternatively, like the pattern PA4 illustrated in FIG. 9, the communication updating process may be a process which causes the access point 20 which carries out wireless communication using one channel (e.g., a ch36) on the 5 GHz (W52) band using the preexisting wireless LAN interface 234 to concurrently carry out wireless communication using another channel (e.g., a ch100) on the 5 GHz (W56) band using the added-on wireless LAN interface 334.

Further, the access point 20 may have a plurality of external device interfaces, and two or more added-on wireless LAN interfaces 334 may be connected to the interfaces. In the case, for example, like the pattern PA5 illustrated in FIG. 9, the communication updating process may cause the access point 20 which carries out the wireless communication on the 2.4 GHz band using the preexisting wireless LAN interface 234 to concurrently carry out wireless communication using one channel (e.g., a ch36) on the 5 GHz (W52) band using the added-on wireless LAN interface 334 as well as wireless communication using another channel (e.g., a ch100) on the 5 GHz (W56) band using the added-on wireless LAN interface 334.

Further, the access point 20 may have a plurality of the preexisting wireless LAN interfaces 234. In the case, for example, like the pattern PA6 illustrated in FIG. 9, the communication updating process may cause the access point 20, which carries out wireless communication on the 2.4 GHz band using a first one of the preexisting wireless LAN interfaces 234 and wireless communication using one channel (e.g., a ch36) on the 5 GHz (W52) band using a second one of the preexisting wireless LAN interfaces 234, to concurrently carry out wireless communication using another channel (e.g., a ch100) on the 5 GHz (W56) band using the added-on wireless LAN interface 334. Further, the present invention is not limited to the 2.4 GHz band or the 5 GHz band, but any frequency band which may be usable for a wireless LAN in the future may be applicable.

Further, in the above embodiments, the communication switching process (FIG. 4) is performed after the communication updating process (FIG. 3). However, the communication switching process need not necessarily be performed after the communication updating process. For example, after the communication updating process, a user may operate the user's client CL to switch the connection wireless interface of the access point 20, whereby as in the case of using the communication switching process in the above embodiments, the substantial throughput of the whole network can be improved. In addition, influence of noises generated by devices, other than the wireless LAN, such as microwave ovens and cordless telephones can be avoided.

It should be noted that the present invention may be realized in various modes, and for example, may be realized by: a wireless communication device; a wireless communication system including the wireless communication device; a method for controlling the device or the system; a computer program executing the method, or the functions of the device or the system; a storage medium having the computer program stored therein; and the like.

What is claimed is:

1. A wireless communication device functioning as a wireless LAN access point, the wireless communication device comprising:
a first wireless LAN interface;
a communication control section configured to carry out, using the first wireless LAN interface, wireless communication with wireless LAN clients on a first frequency;
an external device interface for connection with an external device; and
a communication updating section configured to, when an external device having a second wireless LAN interface has been connected to the external device interface, cause the communication control section to carry out, concurrently with wireless communication using the first wireless LAN interface with wireless LAN client(s) on the first frequency, wireless communication using the second wireless LAN interface with wireless LAN client(s) on a second frequency that is different from the first frequency.

2. The wireless communication device according to claim 1, further comprising
a communication switching section configured to, when the external device having the second wireless LAN interface has been connected to the external device interface, cause the communication control section to switch the wireless communication with one or more of the at least one of the wireless LAN clients that carry out the wireless communication using the first wireless LAN interface and are configure to carry out wireless communication on the second frequency, from the wireless communication using the first wireless LAN interface to the wireless communication using the second wireless LAN interface.

3. The wireless communication device according to claim 2, wherein
the communication updating section causes the communication control section to carry out the wireless communication using the first wireless LAN interface and the wireless communication using the second wireless LAN interface using a single network identifier,
the communication switching section causes the communication control section to stop transmitting responses to the wireless LAN clients using the first wireless LAN interface when the external device having the second wireless LAN interface has been connected to the external device interface, and to restart transmitting the responses to the wireless LAN clients using the first wireless LAN interface after a lapse of a predetermined period of time.

4. The wireless communication device according to claim 2, wherein
the communication updating section causes the communication control section to carry out the wireless communication using the first wireless LAN interface and the wireless communication using the second wireless LAN interface using a single network identifier,
the communication switching section collects corresponding frequency information which indicates whether the wireless LAN clients carrying out wireless communication are configured to carry out the wireless communication on the second frequency, and refers to the corresponding frequency information when the external device having the second wireless LAN interface has been connected to the external device interface, to cause the communication control section to stop transmitting, using the first wireless LAN interface, responses to the at least one of the wireless LAN clients that are configured to carry out the wireless communication on the second frequency.

5. The wireless communication device according to claim 4, wherein the communication switching section refers to the corresponding frequency information to select at least one of the wireless LAN clients with respect to whom transmission of the response using the first wireless LAN interface is to be stopped, so that a load of the wireless communication using the first wireless LAN interface and a load of the wireless communication using the second wireless LAN interface, which are carried out by the communication control section, are substantially equal to each other.

6. The wireless communication device according to claim 3, wherein the communication updating section causes the communication control section to carry out the wireless communication using the first wireless LAN interface and the wireless communication using the second wireless LAN interface using a single network identifier and a single set of authentication and encryption parameters.

7. The wireless communication device according to claim 4, wherein the communication updating section causes the communication control section to carry out the wireless communication using the first wireless LAN interface and the wireless communication using the second wireless LAN interface using a single network identifier and a single set of authentication and encryption parameters.

8. The wireless communication device according to claim 1, wherein the communication updating section obtains a maintenance program file for updating a function of the communication control section, executes the maintenance program file, and updates the function of the communication control section so that the communication control section is configured to carry out, concurrently with the wireless communication on the first frequency using the first wireless LAN interface, the wireless communication on the second frequency using the second wireless LAN interface.

9. The wireless communication device according to claim 8, further comprising
an external network interface for connection with an external network, wherein
the communication updating section is configured to obtain the maintenance program file, which is stored in predetermined storage means on the external network, using the external network interface.

10. The wireless communication device according to claim 8, wherein
the external device having the second wireless LAN interface includes storage means for storing the maintenance program file, and
the communication updating section obtains, using the external device interface, the maintenance program file stored in the storage means of the external device.

11. A method for controlling a wireless communication device which includes a first wireless LAN interface and an external device interface for connection with an external device, and which functions as a wireless LAN access point, the method comprising the processes of:
(a) causing the wireless communication device to carry out, using the first wireless LAN interface, wireless communication with wireless LAN clients on a first frequency; and
(b) causing the wireless communication device, when the external device which has a second wireless LAN interface has been connected to the external device interface, to carry out, concurrently with wireless communication with the wireless LAN client(s) on the first frequency using the first wireless LAN interface, wireless communication using the second wireless LAN interface with wireless LAN client(s) on a second frequency that is different from the first frequency.

12. An access point comprising:
an internal interface for wireless communications on a first frequency;
a host interface with which an add-on device having an added-on wireless interface is connectable, for enabling wireless communications on a second frequency different from the first frequency;
a control section for controlling communications with wireless LAN clients on the first frequency via the internal wireless interface and with wireless LAN clients on the second frequency via the host interface, and configured to recognize an add-on device by type when connected to the host interface; and
a communications control updating section for updating access-point control of communications, in response to recognition of add-on device type by said control section, to enable wireless communications via the host interface and add-on device on the second frequency concurrently with wireless communications via the internal interface on the first frequency.

13. A wireless communications system comprising the access point of claim 12, and an add-on device, connectable with said access point by means of a compatible added-on wireless interface, for wireless communications on the second frequency.
